(19) United States
(12) Patent Application Publication
(10) Pub. No.: US 2020/0342190 A1
(43) Pub. Date: Oct. 29, 2020

(54) RADIO FREQUENCY IDENTIFICATION TECHNOLOGY-BASED ELECTROINIC DEVICE, AND CONTROL METHOD

(71) Applicant: ZICT TECHNOLOGY CO., LTD., Shenzhen (CN)

(72) Inventor: Xingying LI, Shenzhen (CN)

(73) Assignee: ZICT TECHNOLOGY CO., LTD., Shenzhen (CN)

(21) Appl. No.: 16/958,928

(22) PCT Filed: Jul. 17, 2018
(86) PCT No.: PCT/CN2018/095936

§ 371 Date: Jun. 29, 2020

(30) Foreign Application Priority Data
Dec. 29, 2017 (CN) 201711477545.1

(51) Int. Cl. G06K 7/10; G06K 19/07

(52) U.S. Cl. CPC G06K 7/10366; G06K 19/0723

(57) ABSTRACT

Provided are an RFID technology-based electronic device and control method. The electronic device includes: a radio frequency electronic tag, which is configured to be connected to a radio frequency electronic tag identification reader/writer when entering a preset range of the radio frequency electronic tag identification reader/writer; a processor, which is connected to the radio frequency electronic tag and configured to control the radio frequency electronic tag to receive, send and store information; at least one of a fingerprint identification module or a key module, where the fingerprint identification module is connected to the processor and configured to collect first fingerprint information, the key module is connected to the processor and configured to acquire first password information.

The present disclosure claims priority to Chinese patent application No. 201711477545.1 filed on Dec. 29, 2017 and titled RFID-BASED ELECTRONIC DEVICE, AND CONTROL METHOD THEREOF, disclosure of which is incorporated herein by reference in its entirety.

### TECHNICAL FIELD

The present disclosure relates to the field of radio frequency wireless identification, for example, to a radio frequency identification (RFID) technology-based electronic device and an RFID technology-based control method.

### BACKGROUND

An electronic student identification (ID) card with an active electronic tag of dual frequencies of 2.4 G and 13.56M gradually replaces a product such as a campus card system and is widely applied to usage scenarios such as campus attendance, access control, campus consumption, and question answering in classrooms.

In the related art, the electronic student ID card generally stores merely student identification (ID) information, and a campus security or consumption system merely reads the student ID information and compares whether the student ID information exists in a campus system. If the student ID information exists in the campus system, an access or consumption is allowed. However, while a user uses the electronic student ID card, no measures can be taken to perform identification authentication on the user, or the user's identification can merely be verified by manual sampling, which is time-consuming, effort-consuming and inefficient. Therefore, the electronic student ID card is easily used and swiped in a stolen way, which has brought great hidden hazards to campus access control and attendance and the safety of campus consumption.

### SUMMARY

The present disclosure solves at least the problem in the related art that an electronic credential is easily used and swiped in a stolen way.

The present disclosure provides an RFID technology-based electronic device. The electronic device includes a radio frequency electronic tag, a processor, at least one of a fingerprint identification module or a key module, and an identification authentication and feedback module.

The radio frequency electronic tag is configured to be connected to a radio frequency electronic tag identification reader/writer when entering a preset range of the radio frequency electronic tag identification reader/writer.

The processor is connected to the radio frequency electronic tag and configured to control the radio frequency electronic tag to receive, send and store information.

The fingerprint identification module is connected to the processor and configured to collect first fingerprint information of a user when an identification authentication instruction is received from the radio frequency electronic tag identification reader/writer. The key module is disposed on an outer surface of the electronic device, connected to the processor, and configured to acquire first password information inputted by the user.

The processor is further configured to perform at least one of the following operations: when the first fingerprint information is collected by the fingerprint identification module, comparing the first fingerprint information with pre-stored second fingerprint information to obtain a first comparison result, or when the first password information is acquired by the key module, comparing the first password information with preset second password information to obtain a second comparison result.

The identification authentication and feedback module is connected to the processor and configured to generate identification authentication and feedback information according to a comparison result, and forward the identification authentication and feedback information to a server through the radio frequency electronic tag identification reader/writer for the server to determine whether identification authentication succeeds according to the identification authentication and feedback information, where the comparison result includes at least one of: the first comparison result of the first fingerprint information and the second fingerprint information or the second comparison result of the first password information and the second password information.

The present disclosure further provides an RFID technology-based control method which is applied to a client (electronic device). The control method includes steps described below. An identification authentication instruction is received from a radio frequency electronic tag identification reader/writer, and at least one of the following operations is performed: first fingerprint information of a user is collected and compared with pre-stored second fingerprint information to obtain a first comparison result, or first password information inputted by the user is acquired and compared with preset second password information to obtain a second comparison result.

Identification authentication and feedback information is generated according to a comparison result, where the comparison result includes at least one of: the first comparison result of the first fingerprint information and the second fingerprint information or the second comparison result of the first password information and the second password information.

In response to the identification authentication instruction, the identification authentication and feedback information is fed back to the radio frequency electronic tag identification reader/writer, so that the radio frequency electronic tag identification reader/writer forwards the identification authentication and feedback information to a server to enable the server to determine whether identification authentication succeeds according to the identification authentication and feedback information.

The present disclosure further provides an RFID technology-based control method which is applied to a server. The control method includes steps described below. When an electronic device enters a preset range of a radio frequency electronic tag identification reader/writer, the radio frequency electronic tag identification reader/writer is controlled to send an identification authentication instruction, so that the electronic device performs, according to the identification authentication instruction, at least one of the following operations: first fingerprint information of a user is collected and compared with pre-stored second fingerprint information to obtain a first comparison result, or first password information inputted by the user is acquired and compared with preset second password information to obtain a second comparison result, and generates identification authentication and feedback information according to a comparison result, where the comparison result includes the first comparison result of the first fingerprint information and the second fingerprint information or the second comparison result of the first password information and the second password information.

The identification authentication and feedback information is acquired. It is determined whether identification authentication succeeds according to the identification authentication and feedback information, and a corresponding operation is performed.

According to the technical solutions described above, at least one of the fingerprint identification module, the key module or the like may be disposed in the electronic device to perform at least one of the following operations: collecting the first fingerprint information of the user or acquiring the first password information inputted by the user, which facilitates the identification of a person who currently uses the electronic device, and can effectively reduce a phenomenon that the electronic device is swiped in a stolen way and improve usage security performance of the electronic device.

Additional aspects and advantages of the present disclosure will be set forth in the following description, will be apparent in part from the following description, or may be understood through practices of the present disclosure.

### BRIEF DESCRIPTION OF DRAWINGS

FIG. 1 is a schematic block diagram of an RFID technology-based electronic device according to an embodiment of the present disclosure;

FIG. 2 is a schematic block diagram of an RFID technology-based electronic device according to another embodiment of the present disclosure;

FIG. 3 is a schematic flowchart of an RFID technology-based control method according to an embodiment of the present disclosure;

FIG. 4 is a schematic flowchart of an RFID technology-based control method according to another embodiment of the present disclosure; and

FIG. 5 is a schematic flowchart of an RFID technology-based control method according to another embodiment of the present disclosure.

### DETAILED DESCRIPTION

The present disclosure is further described below in conjunction with the drawings and specific embodiments.

### Embodiment One

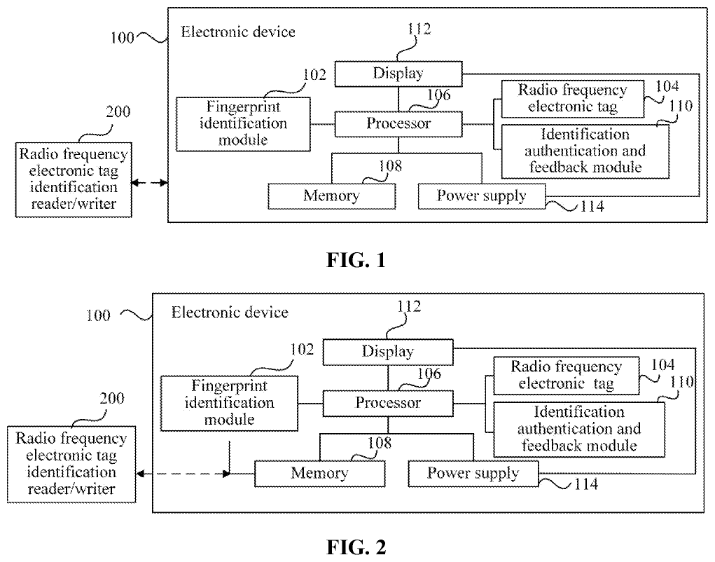

FIG. 1 is a schematic block diagram of an RFID technology-based electronic device 100 according to an embodiment of the present disclosure.

As shown in FIG. 1, the RFID technology-based electronic device 100 according to the embodiment of the present disclosure includes a radio frequency electronic tag 104, a processor 106, at least one of a fingerprint identification module 102 or a key module, and an identification authentication and feedback module 110.

The radio frequency electronic tag 104 is configured to be connected to a radio frequency electronic tag identification reader/writer 200 when entering a preset range of the radio frequency electronic tag identification reader/writer 200.

The processor 106 is connected to the radio frequency electronic tag 104 and configured to control the radio frequency electronic tag 104 to receive, send and store information.

The fingerprint identification module 102 is connected to the processor 106 and configured to collect first fingerprint information of a user when an identification authentication instruction is received from the radio frequency electronic tag identification reader/writer 200. The key module is disposed on an outer surface of the electronic device 100, connected to the processor 106, and configured to acquire first password information inputted by the user.

The processor 106 is further configured to perform at least one of the following operations: when the fingerprint identification module 102 succeeds in collecting the first fingerprint information, comparing the first fingerprint information with pre-stored second fingerprint information to obtain a first comparison result, or when the key module succeeds in acquiring the first password information, comparing the first password information with preset second password information to obtain a second comparison result.

The identification authentication and feedback module 110 is connected to the processor 106 and configured to generate identification authentication and feedback information according to a comparison result, and forward the identification authentication and feedback information to a server through the radio frequency electronic tag identification reader/writer 200 for the server to determine whether identification authentication succeeds according to the identification authentication and feedback information, where the comparison result includes at least one of: the first comparison result of the first fingerprint information and the second fingerprint information or the second comparison result of the first password information and the second password information.

In the embodiment, at least one of the following operations is performed: the first fingerprint information of the user is collected and compared with the pre-stored second fingerprint information, or the first password information inputted by the user is acquired and compared with the preset second password information, so that when the user uses the electronic device 100, the identification authentication is performed on the user, reducing a phenomenon that the electronic device 100 is used in a stolen way and improving usage security performance of the electronic device 100.

In an embodiment, the radio frequency electronic tag 104 is further configured to allow the radio frequency electronic tag identification reader/writer 200 to acquire pre-stored identification information and to forward the identification information to the server when entering the preset range of the radio frequency electronic tag identification reader/writer 200, so that the server matches the identification information, and determines whether the identification authentication succeeds in conjunction with a matching result and the identification authentication and feedback information.

In an embodiment, the electronic device 100 further includes a memory 108, which is connected to the processor 106 and configured to store the identification information and the second fingerprint information.

The electronic device 100 is preset with a unique number, and the identification information and the second fingerprint information recorded in correspondence with the number are written into the radio frequency electronic tag 104 through the radio frequency electronic tag identification reader/writer 200 and stored in the memory 108.

In an embodiment, the electronic device 100 further includes a display 112 and a power supply 114. The display 112 is connected to the processor 106 and configured to display prompt information that the identification authentication succeeds or that the identification authentication fails. The power supply 114 is connected to the display 112 and the processor 106, and configured to supply power to the display 112 and the processor 106.

In an embodiment, the radio frequency electronic tag 104 includes at least one of a 2.4 G radio frequency electronic tag or a 13.56M radio frequency electronic tag.

In an embodiment, the electronic device 100 is any one of an electronic student ID card, an electronic school badge, an electronic charm or an electronic bracelet.

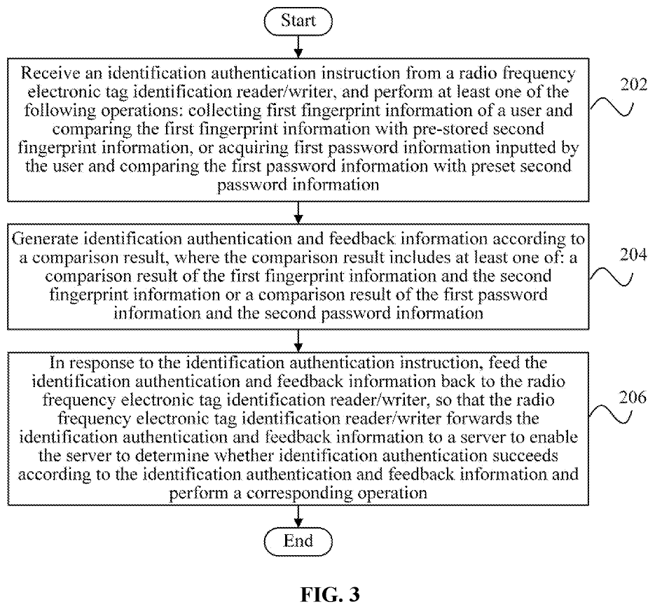

Referring to FIG. 2, in an embodiment, the electronic device 100 includes the fingerprint identification module 102, the radio frequency electronic tag 104, the processor 106, and the memory 108. The fingerprint identification module 102 is configured to collect the first fingerprint information of the user when the identification authentication instruction is received from the radio frequency electronic tag identification reader/writer 200. The radio frequency electronic tag 104 is configured to allow the radio frequency electronic tag identification reader/writer 200 to acquire corresponding information pre-stored in the memory 108 to implement a corresponding function according to the information when entering the preset range of the radio frequency electronic tag identification reader/writer 200. The processor 106 is connected to the fingerprint identification module 102 and the radio frequency electronic tag 104, and configured to control the radio frequency electronic tag 104 to receive, send and store information and compare the first fingerprint information of the user collected by the fingerprint identification module 102 with the second fingerprint information pre-stored in the memory 108 for the identification authentication of the user. The memory 108 is connected to the fingerprint identification module 102 and the processor 106, and configured to store the identification information and the second fingerprint information of a user. The electronic device 100 is preset with the unique number, and the identification information and the second fingerprint information recorded in correspondence with the number are written into the radio frequency electronic tag 104 through the radio frequency electronic tag identification reader/writer 200 and stored in the memory 108.

In the embodiment, the fingerprint identification module 102 may collect the first fingerprint information of the user when the identification authentication instruction is received from the radio frequency electronic tag identification reader/writer 200, which provides data support for the identification authentication of the user. The radio frequency electronic tag 104 allows the radio frequency electronic tag identification reader/writer 200 to acquire the corresponding information pre-stored in the memory 108 when entering the preset range of the radio frequency electronic tag identification reader/writer 200, which is beneficial to the implementation of the corresponding function such as campus attendance, access control, campus consumption, or question answering in classrooms according to the information. The processor 106 connected to the fingerprint identification module 102, the radio frequency electronic tag 104 and the memory 108 may control the radio frequency electronic tag 104 to receive, send and store the information, so as to implement functions such as campus attendance, access control, campus consumption, and question answering in classrooms, improving the applicability of the electronic device 100, and thereby improving usage convenience of the user. The processor 106 compares the first fingerprint information of the user collected by the fingerprint identification module 102 with the second fingerprint information pre-stored in the memory 108 for the identification authentication of the user, which can identify the user, effectively reduce the phenomenon that the electronic device 100 is swiped in the stolen way, and improve the usage security performance of the electronic device 100. The memory 108 connected to the fingerprint identification module 102 and the processor 106 may store the identification information and the second fingerprint information, which is beneficial to the identification authentication of the user when the user uses the electronic device 100, reduces the phenomenon that the electronic device 100 is used in the stolen way, and further improves the usage security performance of the electronic device 100.

The electronic device 100 is preset with the unique number, and the identification information and the second fingerprint information recorded in correspondence with the number are written into the radio frequency electronic tag 104 through the radio frequency electronic tag identification reader/writer 200 and stored in the memory 108. In an embodiment, the identification information includes at least one of identification number information, student number information or name information.

In an embodiment, the preset range may be a range with a center of the radio frequency electronic tag identification reader/writer 200 and a radius of 1 m.

As shown in FIG. 2, in the above-mentioned embodiments, the electronic device 100 further includes the identification authentication and feedback module 110. The identification authentication and feedback module 110 is connected to the processor 106, and configured to generate the identification authentication and feedback information according to the comparison result of the first fingerprint information of the user collected by the fingerprint identification module 102 and the second fingerprint information pre-stored in the memory 108, and forward the identification authentication and feedback information to the server through the radio frequency electronic tag identification reader/writer 200, so that the server determines whether the identification authentication succeeds according to the identification authentication and feedback information and performs the corresponding operation.

In the embodiment, the identification authentication and feedback module 110 connected to the processor 106 may generate the identification authentication and feedback information according to the comparison result of the first fingerprint information of the user collected by the fingerprint identification module 102 and the second fingerprint information pre-stored in the memory 108, and forward the identification authentication and feedback information to the server through the radio frequency electronic tag identification reader/writer 200, which helps the server to determine in time whether the identification authentication succeeds according to the identification authentication and feedback information and perform the corresponding operation. On the one hand, identification authentication efficiency of the electronic device 100 is improved. On the other hand, the usage security performance of the electronic device 100 is further improved.

In an embodiment, performing the corresponding operation includes, but is not limited to, opening an access, not opening the access, succeeding in the campus attendance, failing in the campus attendance, allowing the campus consumption or forbidding the campus consumption.

As shown in FIG. 2, in any one of the above-mentioned embodiments, the electronic device 100 further includes the display 112 and a power supply 114. The display 112 is connected to the processor 106 and configured to display prompt information that the identification authentication succeeds or that the identification authentication fails. The power supply 114 is connected to the display 112 and the processor 106, and configured to supply power to the display 112 and the processor 106.

In the embodiment, the display 112 connected to the processor 106 may display corresponding prompt information, for example, prompt information for the identification authentication such as the prompt information that the identification authentication succeeds or that the identification authentication fails, which helps the user to cooperate to perform corresponding operations and improves the identification authentication efficiency; and the power supply 114 connected to the display 112 and the processor 106 may supply power to the electronic device 100, which is beneficial to continuous usage of the electronic device 100 and reduces the inconvenience to use the electronic device 100 caused by low power.

In an embodiment, the electronic device 100 further includes the key module. The key module is disposed on the outer surface of the electronic device 100, connected to the processor 106, and configured to acquire the first password information inputted by the user. The processor 106 is further configured to compare the first password information with the preset second password information for the identification authentication of the user.

In the embodiment, the key module disposed on the outer surface of the electronic device 100 and connected to the processor 106 may acquire the first password information inputted by the user, and the processor 106 compares the first password information with the preset second password information for the identification authentication of the user, which further improves the usage security performance of the electronic device and can effectively reduce the phenomenon that the electronic device is swiped in the stolen way.

In an embodiment, the electronic radio frequency tag includes at least one of the 2.4 G electronic radio frequency tag or the 13.56M radio frequency electronic tag.

In the embodiment, the electronic radio frequency tag includes at least one of the 2.4 G electronic radio frequency tag or the 13.56M radio frequency electronic tag, which is beneficial to information receiving, sending and storing.

In an embodiment, the 2.4 G radio frequency electronic tag and the 13.56M radio frequency electronic tag have unique electronic codes and can support fast reading and writing of user information. The 13.56M radio frequency electronic tag supports contact card swiping, and is mostly applied to usage scenarios such as the consumption and the access control. The 2.4 G radio frequency electronic tag supports contactless card swiping, long-distance card swiping and multi-target simultaneous card swiping, and is mostly applied to usage scenarios such as the campus attendance and the question answering in classrooms.

In an embodiment, the electronic device 100 is any one of the electronic student ID card, the electronic school badge, the electronic charm or the electronic bracelet.

### Embodiment Two

FIG. 3 is a schematic flowchart of an RFID technology-based control method according to an embodiment of the present disclosure.

As shown in FIG. 3, the RFID technology-based control method according to the embodiment of the present disclosure is applied to a client (electronic device) and includes steps 202, 204 and 206.

In step 202, an identification authentication instruction is received from a radio frequency electronic tag identification reader/writer, and at least one of the following operations is performed: first fingerprint information of a user is collected and compared with pre-stored second fingerprint information to obtain a first comparison result, or first password information inputted by the user is acquired and compared with preset second password information to obtain a second comparison result.

In step 204, identification authentication and feedback information is generated according to a comparison result, where the comparison result includes at least one of: the first comparison result of the first fingerprint information and the second fingerprint information or the second comparison result of the first password information and the second password information. In step 206, in response to the identification authentication instruction, the identification authentication and feedback information is fed back to the radio frequency electronic tag identification reader/writer, so that the radio frequency electronic tag identification reader/writer forwards the identification authentication and feedback information to a server to enable the server to determine whether identification authentication succeeds according to the identification authentication and feedback information and perform a corresponding operation.

In the embodiment, when the identification authentication instruction is received from the radio frequency electronic tag identification reader/writer, at least one of the following operations is performed: the first fingerprint information of the user is collected or the first password information inputted by the user is acquired, which provides data support for the identification authentication of the user; at least one of the following operations is performed: the first fingerprint information is compared with the pre-stored second fingerprint information, or the first password information is compared with the preset second password information, and the identification authentication and feedback information is generated according to the comparison result, which helps the server to determine in time whether the identification authentication succeeds according to the identification authentication and feedback information; in response to the identification authentication instruction, the identification authentication and feedback information is fed back to the radio frequency electronic tag identification reader/writer, so that the radio frequency electronic tag identification reader/writer forwards the identification authentication and feedback information to the server, which helps the server to determine whether the identification authentication succeeds according to the identification authentication and feedback information and perform the corresponding operation. On the one hand, identification authentication efficiency of the electronic device is improved. On the other hand, usage security performance of the electronic device is further improved.

In an embodiment, performing the corresponding operation includes, but is not limited to, opening an access, not opening the access, succeeding in campus attendance, failing in the campus attendance, allowing campus consumption or forbidding the campus consumption.

In an embodiment, the radio frequency electronic tag identification reader/writer is provided with at least one of a wireless-fidelity (wifi) communication unit or a 4 G network communication unit, which may be communicatively connected to the server; and a radio frequency electronic tag of the electronic device may be communicatively connected to the radio frequency electronic tag identification reader/writer through radio frequencies when their distance is less than a certain preset range, for example, a circle with a diameter of 1 m.

In an embodiment, the method further includes: when entering a preset range of the radio frequency electronic tag identification reader/writer, feeding pre-stored identification information back in response to the radio frequency electronic tag identification reader/writer, so that the radio frequency electronic tag identification reader/writer forwards the identification information to the server to enable the server to match the identification information, determine whether the identification authentication succeeds in conjunction with a matching result and the identification authentication and feedback information, and perform the corresponding operation.

In the embodiment, when the preset range of the radio frequency electronic tag identification reader/writer is entered, the pre-stored identification information is fed back to the radio frequency electronic tag identification reader/writer in response to the radio frequency electronic tag identification reader/writer, so that the radio frequency electronic tag identification reader/writer forwards the identification information to the server and the server determines whether the identification authentication succeeds according to the identification information and the identification authentication and feedback information, and performs the corresponding operation, further improving the usage security performance of the electronic device.

In an embodiment, the server has a preset user identification information library. When the identification information is matched in the preset user identification information library, it is determined that the identification authentication succeeds, which can only indicate that the user of the electronic device is in the preset user identification information library and cannot identify the current user of the electronic device, and at least one of the following operations is performed: the first fingerprint information is compared with the pre-stored second fingerprint information, or the first password information is compared with the preset second password information, which can identify the current user of the electronic device. The two identification authentication manners are combined, further improving the usage security performance of the electronic device and effectively reducing the phenomenon that the electronic device is swiped in a stolen way.

In an embodiment, the radio frequency electronic tag identification reader/writer may be preset. For a card swiping point with a lower usage security performance requirement, only the identification information is used for authentication. For a card swiping point with a higher usage security performance requirement, fingerprint information may be combined with the identification information for authentication, or password information may be combined with the identification information for authentication.

In an embodiment, the preset range may be a range with a center of the radio frequency electronic tag identification reader/writer and a radius of 1 m.

In an embodiment, the method further includes: pre-storing the identification information and the second fingerprint information in a memory, where the electronic device is preset with a unique number, and the identification information and the second fingerprint information recorded in correspondence with the number are written into the radio frequency electronic tag through the radio frequency electronic tag identification reader/writer and stored in the memory.

In the embodiment, the identification information and the second fingerprint information are pre-stored in the memory. The identification information and the second fingerprint information may be stored, which facilities the identification authentication of the user when the electronic device is used, further reduces the phenomenon that the electronic device is used in a stolen way, and further improves the usage security performance of the electronic device.

The electronic device is preset with the unique number, and the identification information and the second fingerprint information recorded in correspondence with the number are written into the radio frequency electronic tag through the radio frequency electronic tag identification reader/writer and stored in the memory. In an embodiment, the identification information includes at least one of identification number information, student number information or name information.

In an embodiment, the method further includes: receiving information on whether the identification authentication succeeds from the server, and displaying corresponding first prompt information.

In the embodiment, the information on whether the identification authentication succeeds is received from the server, and the corresponding first prompt information is displayed, so that the user performs a corresponding operation according to the corresponding first prompt information, improving usage efficiency of the electronic device.

For example, when the identification authentication succeeds, prompt information that the identification authentication succeeds is displayed, and the user may pass an access in time, leave an attendance area in time, etc. For example, when the identification authentication fails, prompt information that the identification authentication fails is displayed, and the user may press a fingerprint or input a password again in time, or ask a person in charge to check whether the electronic device is faulty. In addition, when the identification authentication fails, the radio frequency electronic tag identification reader/writer will also utter an alert sound, which helps the person in charge to find an anomaly in time and make a corresponding response.

In an embodiment, the method further includes: when the identification authentication instruction is received from the radio frequency electronic tag identification reader/writer, displaying corresponding second prompt information for the user to cooperate according to the second prompt information to complete at least one of the following operations: collecting the first fingerprint information or inputting the first password information.

In an embodiment, when the identification authentication instruction is received from the radio frequency electronic tag identification reader/writer, the corresponding second prompt information is displayed, so that the user cooperates according to the second prompt information to complete at least one of the following operations: collecting the first fingerprint information or inputting the first password information, further improving the identification authentication efficiency and further improving the convenience to use the electronic device.

### Embodiment Three

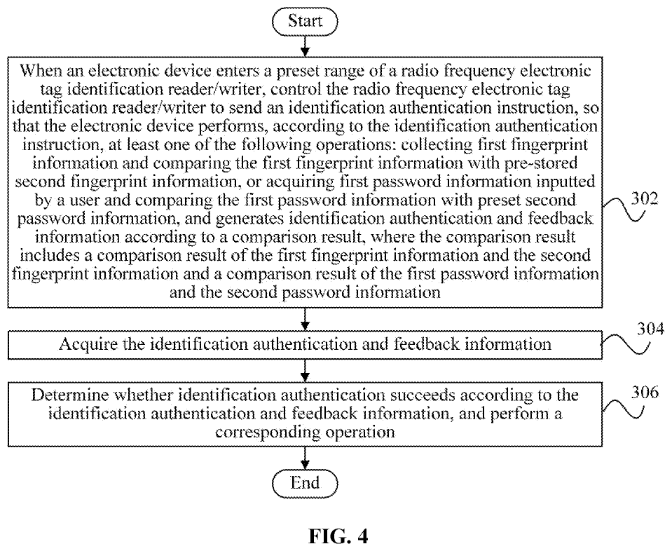

FIG. 4 is a schematic flowchart of an RFID technology-based control method according to another embodiment of the present disclosure.

As shown in FIG. 4, the RFID technology-based control method according to the embodiment of the present disclosure is applied to a server and includes steps 302, 304 and 306.

In step 302, when an electronic device enters a preset range of a radio frequency electronic tag identification reader/writer, the radio frequency electronic tag identification reader/writer is controlled to send an identification authentication instruction, so that the electronic device performs, according to the identification authentication instruction, at least one of the following operations: collecting first fingerprint information and comparing the first fingerprint information with pre-stored second fingerprint information to obtain a first comparison result, or acquiring first password information inputted by a user and comparing the first password information with preset second password information to obtain a second comparison result, and generates identification authentication and feedback information according to a comparison result, where the comparison result includes at least one of: the first comparison result of the first fingerprint information and the second fingerprint information or the second comparison result of the first password information and the second password information.

In step 304, the identification authentication and feedback information is acquired.

In step 306, it is determined whether identification authentication succeeds according to the identification authentication and feedback information, and a corresponding operation is performed.

In the embodiment, when the electronic device enters the preset range of the radio frequency electronic tag identification reader/writer, the radio frequency electronic tag identification reader/writer is controlled to send the identification authentication instruction, so that a client performs, according to the identification authentication instruction, at least one of the following operations: collecting the first fingerprint information and comparing the first fingerprint information with the pre-stored second fingerprint information, or acquiring the first password information inputted by the user and comparing the first password information with the preset second password information, and generates the identification authentication and feedback information according to the comparison result, where the comparison result includes the comparison result of the first fingerprint information and the second fingerprint information and the comparison result of the first password information and the second password information, thereby providing data support for determining whether the identification authentication succeeds. The identification authentication and feedback information is acquired, it is determined whether the identification authentication succeeds according to the identification authentication and feedback information, and the corresponding operation is performed, so that the identification authentication is performed on the user when the electronic device is used, which can identify the user of the electronic device and determine whether the user of the electronic device is a registered user of the electronic device, further improves usage security performance of the electronic device, and effectively reduces the phenomenon that the electronic device is swiped in a stolen way.

In an embodiment, performing the corresponding operation includes, but is not limited to, opening an access, not opening the access, succeeding in campus attendance, failing in the campus attendance, allowing campus consumption or forbidding the campus consumption.

In an embodiment, the step in which it is determined whether the identification authentication succeeds according to the identification authentication and feedback information, and the corresponding operation is performed includes steps described below. In response to the identification authentication and feedback information that the first fingerprint information is the same as the pre-stored second fingerprint information and/or the password information inputted by the user is the same as the preset password information, the server determines that the identification authentication succeeds, and is controlled to perform a corresponding first operation. In response to the identification authentication and feedback information that the first fingerprint information is different from the pre-stored second fingerprint information and/or the password information inputted by the user is different from the preset password information, the server determines that the identification authentication fails, and is controlled to perform a corresponding second operation.

In the embodiment, in response to the identification authentication and feedback information that the first fingerprint information is the same as the pre-stored second fingerprint information and/or the password information inputted by the user is the same as the preset password information, the server determines that the identification authentication succeeds, and is controlled to perform the corresponding first operation such as opening the access, succeeding in the campus attendance, or succeeding in the campus consumption; and in response to the identification authentication and feedback information that the first fingerprint information is different from the pre-stored second fingerprint information and/or the password information inputted by the user is different from the preset password information, the server determines that the identification authentication fails, and is controlled to perform the corresponding second operation such as not opening the access and uttering an alert sound, failing in the campus attendance, failing in the campus consumption or issuing alert information by the electronic radio frequency tag identification reader/writer, further improving the usage security performance of the electronic device.

In an embodiment, the method further includes: when the electronic device enters the preset range of the radio frequency electronic tag identification reader/writer, acquiring identification information from the client; and determining whether the identification authentication succeeds according to the identification authentication and feedback information and the identification information, and performing the corresponding operation.

In the embodiment, when the electronic device enters the preset range of the radio frequency electronic tag identification reader/writer, the identification information is received from the client, it is determined whether the identification authentication succeeds according to the identification authentication and feedback information and the identification information, and the corresponding operation is performed, further improving the usage security performance of the electronic device.

In an embodiment, the server has a preset user identification information library. When the identification information is matched in the preset user identification information library, it is determined that the identification authentication succeeds, which can only indicate that the user of the electronic device is in the preset user identification information library and cannot identify the current user of the electronic device, and at least one of the following operations is performed: the first fingerprint information is compared with the pre-stored second fingerprint information, or the first password information is compared with the preset second password information, which can identify the current user of the electronic device. The two identification authentication manners are combined, further improving the usage security performance of the electronic device and effectively reducing the phenomenon that the electronic device is swiped in a stolen way.

In an embodiment, the radio frequency electronic tag identification reader/writer may be preset. For a card swiping point with a lower usage security performance requirement, only the identification information is used for authentication. For a card swiping point with a higher usage security performance requirement, fingerprint information may be combined with the identification information for authentication, or password information may be combined with the identification information for authentication.

In an embodiment, the preset range may be a range with a center of the radio frequency electronic tag identification reader/writer and a radius of 1 m.

In an embodiment, the step of determining whether the identification authentication succeeds according to the identification authentication and feedback information and the identification information, and performing the corresponding operation includes steps described below. The identification information is matched in the preset user identification information library. In response to a success in matching the identification information in the preset user identification information library, it is determined that the identification authentication succeeds and a corresponding first operation is performed in one of the following three cases: the identification authentication and feedback information is that the first fingerprint information is the same as the second fingerprint information, the identification authentication and feedback information is that the first password information is the same as the second password information, or the identification authentication and feedback information is that the first fingerprint information is the same as the second fingerprint information and the first password information is the same as the second password information. In response to a failure to match the identification information in the preset user identification information library, it is determined that the identification authentication fails and a corresponding second operation is performed in one of the following cases: the identification authentication and feedback information is that the first fingerprint information is different from the second fingerprint information, the identification authentication and feedback information is that the first password information is different from the second password information, or the identification authentication and feedback information is that the first fingerprint information is different from the second fingerprint information and the first password information is different from the second password information.

In the embodiment, the identification information is matched in the preset user identification information library, and in response to the success in matching the identification information in the preset user identification information library, it is determined that the identification authentication succeeds and the corresponding first operation is performed, such as opening the access, succeeding in the campus attendance, or succeeding in the campus consumption; and in response to the failure to match the identification information in the preset user identification information library, it is determined that the identification authentication fails and the corresponding second operation is performed, such as not opening the access and uttering the alert sound, failing in the campus attendance, failing in the campus consumption or issuing the alert information by the radio frequency electronic tag identification reader/writer, further improving the usage security performance of the electronic device.

In an embodiment, the method further includes: sending information on whether the identification authentication succeeds to the client, so that the client displays corresponding first prompt information.

In the embodiment, the information on whether the identification authentication succeeds is sent to the client, so that the client displays the corresponding first prompt information, which is beneficial to the improvement of the identification authentication efficiency, helps the user to perform a corresponding operation according to the corresponding first prompt information, improves usage efficiency of the electronic device.

For example, when the identification authentication succeeds, prompt information that the identification authentication succeeds is displayed, and the user may pass the access in time, leave an attendance area in time, etc. For example, when the identification authentication fails, prompt information that the identification authentication fails is displayed, and the user may press a fingerprint or input a password again in time, or ask a person in charge to check whether the electronic device is faulty. In addition, when the identification authentication fails, the radio frequency electronic tag identification reader/writer will also utter an alert sound, which helps the person in charge to find an anomaly in time and make a corresponding response.

In an embodiment, the method further includes: counting pieces of information that the identification authentication fails; and in response to determining that a number of pieces of information that the identification authentication fails of a same client within first preset time is greater than a preset threshold, controlling the client to be disabled for second preset time, and sending alert prompt information to another client associated with a relevant personnel.

In the embodiment, the pieces of information that the identification authentication fails are counted; and when the number of pieces of information that the identification authentication fails of the same client within the first preset time is greater than the preset threshold, the client is controlled to be disabled for the second preset time, and the alert prompt information is sent to another client associated with the relevant personnel, further improving the usage security performance of the electronic device.

In an embodiment, the first preset time is 10-15 min, the preset threshold is any one of 3, 4 or 5, and the second preset time is 60 min. The technical solution provided by the present disclosure effectively reduces the phenomenon that the electronic device is swiped in a stolen way, reduces the phenomenon of being mistaken as stolen swiping due to the user's mistake, and helps the relevant personnel to deal with a possible stolen swiping phenomenon.

In an embodiment, the method further includes: counting operation records of the first operation after the identification authentication succeeds, and storing the operation records.

In the embodiment, the operation records of the first operation after the identification authentication succeeds are counted and stored, which is beneficial to the query of historical operation records including card consumption records, access records, and campus attendance records, etc., improving the convenience to use the electronic device.

### Embodiment Four

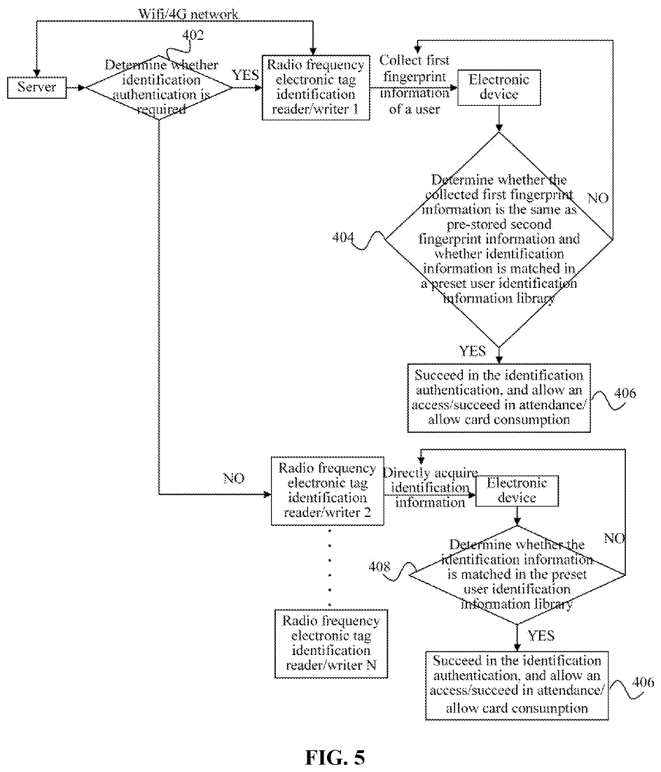

FIG. 5 is a schematic flowchart of a control method for an RFID technology-based electronic device according to another embodiment of the present disclosure.

As shown in FIG. 5, to implement the control method for the RFID technology-based electronic device according to the embodiment of the present disclosure, radio frequency electronic tag reader/writers are placed at different card swiping points. There are multiple radio frequency electronic tag reader/writers, which are radio frequency electronic tag reader/writer 1, radio frequency electronic tag reader/writer 2, . . . , radio frequency electronic tag reader/writer N, separately. It is preset whether identification authentication is required by each of the radio frequency electronic tag reader/writers. For example, it is preset that the identification authentication is required by the radio frequency electronic tag reader/writer 1, and the identification authentication is not required by the radio frequency electronic tag reader/writer 2. The radio frequency electronic tag reader/writer communicates with a server through at least one of wife or a 4 G network. The method includes steps described below.

In step 402, it is determined whether the identification authentication is required.

In an embodiment, when the electronic device enters an identification range of the radio frequency electronic tag reader/writer, it is determined whether it is preset that the identification authentication is required by the radio frequency electronic tag reader/writer.

If it is determined YES in step 402, first fingerprint information of a user is collected by the electronic device, and then step 404 of determining whether the collected first fingerprint information is the same as pre-stored second fingerprint information and whether identification information is matched in a preset user identification information library is performed.

If it is determined YES in step 404, that is, the collected first fingerprint information is the same as the pre-stored second fingerprint information and the identification information is matched in the preset user identification information library, step 406 is performed in which the identification authentication succeeds, and an access is allowed/attendance succeeds/card consumption is allowed.

If it is determined No in step 404, that is, the collected first fingerprint information is different from the pre-stored second fingerprint information and the identification information is not matched in the preset user identification information library, the first fingerprint information of the user is collected by the electronic device, and then step 404 is performed.

If it is determined No in step 402, the identification information is directly acquired through the electronic device, and step 408 of determining whether the identification information is matched in the preset user identification information library is performed.

If it is determined YES in step 408, step 406 is performed in which the identification authentication succeeds, and the access is allowed/the attendance succeeds/the card consumption is allowed.

If it is determined No in step 408, the identification information is acquired through the electronic device, and then step 408 is performed.

In the embodiment, the first fingerprint information of the user is collected and the identification information of the user is acquired for the identification authentication, further improving usage security performance of the electronic device and reducing a phenomenon that the electronic device is swiped in a stolen way.

The technical solutions of the present disclosure are described above with reference to the drawings. The present disclosure provides the RFID technology-based electronic device and the control method for the RFID technology-based electronic device. The electronic device is provided with at least one of the following modules: the fingerprint identification module, the key module and the like, which may acquire at least one of the first fingerprint information of the user and the inputted first password information, which facilitates the identification of the person who uses the electronic device currently, and can effectively reduce the phenomenon that the electronic device is swiped in a stolen way and improve the usage security performance of the electronic device.

It can be understood by those skilled in the art that all or part of the steps of the various methods in the embodiments described above may be implemented by related hardware instructed by programs. The programs may be stored in a computer-readable storage medium. The storage medium includes a read-only memory (ROM), a random access memory (RAM), a programmable read-only memory (PROM), an erasable programmable read only memory (EPROM), a one-time programmable read-only memory (OTPROM), an electrically-erasable programmable read-only memory (EEPROM), a compact disc read-only memory (CD-ROM), or other optical disc memories, magnetic disc memories, magnetic tape memories, or any other computer-readable medium capable of carrying or storing data.

The above are merely the embodiments of the present disclosure and not intended to limit the present disclosure.

What is claimed is:

1. A radio frequency identification (RFID) technology-based electronic device, comprising:
a radio frequency electronic tag, which is configured to be connected to a radio frequency electronic tag identification reader/writer when entering a preset range of the radio frequency electronic tag identification reader/writer;
a processor, which is connected to the radio frequency electronic tag and configured to control the radio frequency electronic tag to receive, send and store information;
at least one of a fingerprint identification module or a key module, wherein the fingerprint identification module is connected to the processor and configured to collect first fingerprint information of a user when an identification authentication instruction is received from the radio frequency electronic tag identification reader/writer; and the key module is disposed on an outer surface of the electronic device, connected to the processor, and configured to acquire first password information inputted by the user;
the processor is further configured to perform at least one of the following operations: when the first fingerprint information is collected by the fingerprint identification module, comparing the first fingerprint information with pre-stored second fingerprint information to obtain a first comparison result, or when the first password information is acquired by the key module, comparing the first password information with preset second password information to obtain a second comparison result; and
an identification authentication and feedback module, which is connected to the processor and configured to generate identification authentication and feedback information according to a comparison result, and forward the identification authentication and feedback information to a server through the radio frequency electronic tag identification reader/writer for the server to determine whether identification authentication succeeds according to the identification authentication and feedback information, wherein the comparison result comprises at least one of: the first comparison result of the first fingerprint information and the second fingerprint information or the second comparison result of the first password information and the second password information.

2. The RFID technology-based electronic device of claim 1, wherein the radio frequency electronic tag is further configured to:
allow the radio frequency electronic tag identification reader/writer to acquire pre-stored identification information and to forward the identification information to the server when entering the preset range of the radio frequency electronic tag identification reader/writer, so that the server matches the identification information to obtain a matching result, and determines whether the identification authentication succeeds in conjunction with the matching result and the identification authentication and feedback information.

3. The RFID technology-based electronic device of claim 2, further comprising:
a memory, which is connected to the fingerprint identification module and the processor, and configured to store the identification information and the second fingerprint information;
wherein the electronic device is preset with a unique number, and the identification information and the second fingerprint information recorded in correspondence with the unique number are written into the radio frequency electronic tag through the radio frequency electronic tag identification reader/writer and stored in the memory.

4. The RFID technology-based electronic device of claim 1, further comprising:
a display, which is connected to the processor and configured to display prompt information that the identification authentication succeeds or that the identification authentication fails; and
a power supply, which is separately connected to the display and the processor, and configured to supply power to the display and the processor.

5. The RFID technology-based electronic device of claim 1, wherein the radio frequency electronic tag comprises at least one of a 2.4 G radio frequency electronic tag or a 13.56M radio frequency electronic tag.

6. The RFID technology-based electronic device of claim 1, wherein the electronic device is any one of an electronic student ID card, an electronic school badge, an electronic charm or an electronic bracelet.

7. A radio frequency identification (RFID) technology-based control method, applied to an electronic device and comprising:
receiving an identification authentication instruction from a radio frequency electronic tag identification reader/writer, and performing at least one of the following operations:
collecting first fingerprint information of a user; and comparing the first fingerprint information with pre-stored second fingerprint information to obtain a first comparison result, or
acquiring first password information inputted by the user; and comparing the first password information with preset second password information to obtain a second comparison result;
generating identification authentication and feedback information according to a comparison result, wherein the comparison result comprises at least one of: the first comparison result of the first fingerprint information and the second fingerprint information or the second comparison result of the first password information and the second password information; and
in response to the identification authentication instruction, feeding the identification authentication and feedback information back to the radio frequency electronic tag identification reader/writer, so that the radio frequency electronic tag identification reader/writer forwards the identification authentication and feedback information to a server to enable the server to determine whether identification authentication succeeds according to the identification authentication and feedback information.

8. The RFID technology-based control method of claim 7, further comprising:
when entering a preset range of the radio frequency electronic tag identification reader/writer, feeding pre-stored identification information back in response to the radio frequency electronic tag identification reader/writer, so that the radio frequency electronic tag identification reader/writer forwards the identification information to the server to enable the server to:
match the identification information to obtain a matching result; and
determine whether the identification authentication succeeds in conjunction with the matching result and the identification authentication and feedback information.

9. The RFID technology-based control method of claim 8, further comprising:
pre-storing the identification information and the second fingerprint information in a memory;
wherein the electronic device is preset with a unique number, and the identification information and the second fingerprint information recorded in correspondence with the unique number are written into a radio frequency electronic tag through the radio frequency electronic tag identification reader/writer and stored in the memory.

10. The RFID technology-based control method of claim 7, further comprising:
receiving, from the server, information indicating whether the identification authentication succeeds; and
displaying first prompt information to prompt whether the identification authentication succeeds.

11. The RFID technology-based control method of claim 7, after receiving the identification authentication instruction from the radio frequency electronic tag identification reader/writer, and before performing at least one of the following operations: collecting the first fingerprint information of the user and comparing the first fingerprint information with the pre-stored second fingerprint information, or acquiring the first password information inputted by the user and comparing the first password information with the preset second password information, further comprising:
displaying second prompt information for the user to cooperate according to the second prompt information to complete at least one of the following operations: collecting the first fingerprint information or inputting the first password information.

12. A radio frequency identification (RFID) technology-based control method, comprising:
when an electronic device enters a preset range of a radio frequency electronic tag identification reader/writer, controlling the radio frequency electronic tag identification reader/writer to send an identification authentication instruction, so that the electronic device performs, according to the identification authentication instruction, at least one of the following operations:
collecting first fingerprint information of a user and comparing the first fingerprint information with pre-stored second fingerprint information to obtain a first comparison result, or acquiring first password information inputted by the user and comparing the first password information with preset second password information to obtain a second comparison result, and
generating identification authentication and feedback information according to a comparison result, wherein the comparison result comprises at least one of: the first comparison result of the first fingerprint information and the second fingerprint information or the second comparison result of the first password information and the second password information;
acquiring the identification authentication and feedback information; and
determining whether identification authentication succeeds according to the identification authentication and feedback information, and performing a corresponding operation.

13. The RFID technology-based control method of claim 12, wherein determining whether the identification authentication succeeds according to the identification authentication and feedback information, and performing the corresponding operation comprises:
in a case where the first fingerprint information is collected, in response to the identification authentication and feedback information indicating that the first fingerprint information is same as the second fingerprint information, determining that the identification authentication succeeds, and performing a corresponding first operation; and in response to the identification authentication and feedback information indicating that the first fingerprint information is different from the second fingerprint information, determining that the identification authentication fails, and performing a corresponding second operation;
in a case where the first password information is acquired, in response to the identification authentication and feedback information indicating that the first password information is same as the second password information, determining that the identification authentication succeeds, and performing a corresponding first operation; and in response to the identification authentication and feedback information indicating that the first password information is different from the second password information, determining that the identification authentication fails, and performing a corresponding second operation; or
in a case where the first fingerprint information is collected and the first password information is acquired, in response to the identification authentication and feedback information indicating that the first fingerprint information is the same as the second fingerprint information and the first password information is the same as the second password information, determining that the identification authentication succeeds, and performing a corresponding first operation; and in response to the identification authentication and feedback information indicating that the first fingerprint information is different from the second fingerprint information or the first password information is different from the second password information, determining that the identification authentication fails, and performing a corresponding second operation.

14. The RFID technology-based control method of claim 12, further comprising:
when the electronic device enters the preset range of the radio frequency electronic tag identification reader/writer, acquiring identification information from the electronic device;
wherein determining whether the identification authentication succeeds according to the identification authentication and feedback information, and performing the corresponding operation comprises: determining whether the identification authentication succeeds according to the identification authentication and feedback information and the identification information, and performing the corresponding operation.

15. The RFID technology-based control method of claim 14, wherein determining whether the identification authentication succeeds according to the identification authentication and feedback information and the identification information, and performing the corresponding operation comprises:
matching the identification information in a preset user identification information library;
in response to determining that the identification information is matched in the preset user identification information library, determining that the identification authentication succeeds and performing a corresponding first operation in one of the following three cases:
the identification authentication and feedback information indicates that the first fingerprint information is same as the second fingerprint information,
the identification authentication and feedback information indicates that the first password information is same as the second password information, or
the identification authentication and feedback information indicates that the first fingerprint information is the same as the second fingerprint information and the first password information is the same as the second password information; and
in response to determining that the identification information is not matched in the preset user identification information library, determining that the identification authentication fails and performing a corresponding second operation in one of the following cases:
the identification authentication and feedback information indicates that the first fingerprint information is different from the second fingerprint information,
the identification authentication and feedback information indicates that the first password information is different from the second password information, or
the identification authentication and feedback information indicates that the first fingerprint information is different from the second fingerprint information and the first password information is different from the second password information.

16. The RFID technology-based control method of claim 12, after determining whether the identification authentication succeeds according to the identification authentication and feedback information, further comprising:
sending information on whether the identification authentication succeeds to the electronic device, so that the electronic device displays corresponding prompt information to prompt whether the identification authentication succeeds.

17. The RFID technology-based control method of claim 12, further comprising:
counting pieces of information indicating that the identification authentication fails; and
in response to determining that a number of pieces of information indicating that the identification authentication fails of the electronic device within a first preset period is greater than a preset threshold, controlling the electronic device to be disabled for second preset time, and sending alert prompt information to a client associated with a relevant personnel.

18. The RFID technology-based control method of claim 15, further comprising:
counting operation records of the first operation after the identification authentication succeeds, and storing the operation records.
